(19) United States
(12) Patent Application Publication
(10) Pub. No.: US 2026/0237943 A1
(43) Pub. Date: Aug. 13, 2026

(54) ELECTRICAL CONNECTOR AND ELECTRICAL CONNECTOR PAIR

(71) Applicant: I-PEX Inc., Kyoto-shi, Kyoto (JP)

(72) Inventor: Akito KOYANAGI, Ogori-shi (JP)

(21) Appl. No.: 19/158,022

(22) PCT Filed: Feb. 14, 2024
(86) PCT No.: PCT/JP2024/004969

§ 371 Date: Aug. 19, 2025

(30) Foreign Application Priority Data
Feb. 20, 2023 (JP) 2023-024698

(51) Int. Cl. H01R 13/6589; H01R 12/75; H01R 13/447; H01R 13/6473

(52) U.S. Cl. CPC H01R 13/6589; H01R 12/75; H01R 13/447; H01R 13/6473

(57) ABSTRACT

An insulative plug housing (20) holds the plurality of plug terminals (21). Each plug terminal (21) includes a plug contact portion (21b) to come in contact with the receptacle terminal, and a cable connecting portion (21c) to connect to the inner conductor. When the plug connector is fitted to the receptacle connector, the plug contact portion (21b) comes in contact, at a portion along the fitting direction, with the receptacle terminal, and the cable connecting portion (21c) connects, at a portion along an inclining direction, with the inner conductor extending in the inclining direction, the inclining direction being a direction inclined from the fitting direction toward an orthogonal direction orthogonal to both an array direction of the plug terminals (21) and the fitting direction.

### TECHNICAL FIELD

The present disclosure relates to an electrical connector and an electrical connector pair.

### BACKGROUND ART

Patent Literature 1 discloses a connector device including a board-side connector and a cable-side connector. The connector device includes two types of signal paths having different path lengths.

### CITATION LIST

### Patent Literature

Patent Literature 1: Unexamined Japanese Patent Application Publication No. 2019-087462.

### SUMMARY OF INVENTION

### Technical Problem

In the device disclosed in Patent Literature 1, the presence of two types of signal paths having different path lengths results in impedance mismatch, leading to degraded transmission characteristics. Furthermore, when the plug connector is fitted to the board-side connector in a normal direction of a mounting surface of a board, reduction in height of the connectors becomes challenging.

The present disclosure has been made in view of the above circumstances, and aims to provide an electrical connector and an electrical connector pair that can achieve reduction in height while achieving impedance matching.

In order to achieve the above-described objective, an electrical connector according to a first aspect of the present disclosure is an electrical connector to be fitted to a mating connector mounted on a board in a normal direction of a mounting surface of the board that is a fitting direction and to connect the mating connector with a signal line, the electrical connector including:
contacts being conductive, arranged in a same orientation, and arrayed to connect to signal transmission members of the mating connector in a one-to-one manner, the signal transmission members being conductive and arrayed on the mounting surface of the board; and
a housing being insulative and holding the contacts, wherein
the contacts each include
   a contact to make contact with the corresponding signal transmission member, and
   a connecting portion to connect to the signal line, and
when the electrical connector is fitted to the mating connector, the contact portion comes in contact, at a portion along the fitting direction, with the signal transmission member, and the connecting portion connects, at a portion along an inclining direction, with the signal line extending in the inclining direction, the inclining direction being a direction inclined from the fitting direction toward an orthogonal direction orthogonal to both an array direction of the contacts and the fitting direction.

The housing may include
a fitting portion that fits to the mating connector, and supports the contact portions on a first plane, the first plane extending in the fitting direction and the array direction, and
a supporting portion that is coupled to the fitting portion, and supports the connecting portion on a second plane, the second plane extending in the inclining direction and the array direction.

In each contact, at least a portion between the contact portion and the connecting portion may be tightly fixed to the housing.

The electrical connector may further include a first shell being conductive,
a pair of adjacent contacts, among the contacts, may transmit a differential signal as a set, and
the first shell may cover at least a portion of the pair of contacts, and may be provided for each pair of contacts in a state in which the first shell is insulated from the contacts.

The first shell may cover a portion of the contact that excludes the contact portion.

The first shell may include an opposing wall portion, the opposing wall portion extending in the inclining direction and the array direction and covering the pair of contacts.

The first shell may include a pair of side wall portions arranged with the pair of contacts therebetween in the array direction.

The electrical connector may include a second shell being conductive, extending in the inclining direction and the array direction, and covering the contacts from an opposite side of the first shell relative to the connecting portion.

The electrical connector may include a cover being conductive and covering an array of the contacts from above the first shell.

An electrical connector pair according to a second aspect of the present disclosure includes:
mating connectors that each include the signal transmission members being conductive and aligned on the mounting surface of the board, and in which the signal transmission members are aligned in an orthogonal direction that is orthogonal to an array direction of the signal transmission members, and to the fitting direction so that the signal transmission members are arranged in a same orientation, and
the electrical connector according to the first aspect of the present disclosure, the electrical connector fitting to the mating connectors in the normal direction of the mounting surface in a one-to-one manner.

### Advantageous Effects of Invention

According to the present disclosure, reduction in height can be achieved while achieving impedance matching.

### BRIEF DESCRIPTION OF DRAWINGS

FIG. 1 is a perspective view illustrating an appearance of an electrical connector pair according to one embodiment of the present disclosure;

FIG. 2 is a diagram illustrating a foot pattern on a mounting surface of a board on which a receptacle connector included in the electrical connector pair illustrated in FIG. 1 is mounted;

FIG. 3 is a perspective view illustrating an end of a coaxial cable;

FIG. 4 is a perspective view illustrating an appearance of the receptacle connector;

FIG. 5 is an exploded perspective view of the receptacle connector illustrated in FIG. 4;

FIG. 6 is a perspective view illustrating receptacle terminals, shield plates, and a ground plate while omitting a receptacle housing;

FIG. 7 is a partially enlarged view of FIG. 6;

FIG. 8A is a diagram illustrating the portion illustrated in FIG. 7, as viewed in an X-axis direction;

FIG. 8B is a diagram illustrating the portion illustrated in FIG. 7, as viewed in a Y-axis direction;

FIG. 9 is a schematic diagram illustrating an example of a route of electromagnetic noise between receptacle terminals;

FIG. 10 is a perspective view illustrating an appearance of a plug connector;

FIG. 11A is a perspective view of a plug housing included in the plug connector;

FIG. 11B is a cross-sectional view obtained by cutting the plug housing illustrated in FIG. 11A along a plane parallel to a YZ plane;

FIG. 12A is a perspective view of a plug terminal included in the plug connector;

FIG. 12B is a partial perspective view of the plug housing on which the plug terminals are mounted;

FIG. 13 is a perspective view illustrating a state in which electrical cables are connected to the plug housing and plug contacts;

FIG. 14A is a perspective view illustrating a state in which first shells are mounted on a configuration including the plug housing, the plug contacts, and the electrical cables;

FIG. 14B is a diagram illustrating a state in which the first shells are rendered transparent and mounted on the plug housing;

FIG. 14C is a perspective view of the first shell;

FIG. 15A is a perspective view of a second shell;

FIG. 15B is a perspective view illustrating a state in which the second shell is mounted on a configuration including the plug housing, the plug contacts, the electrical cables, and the first shells;

FIG. 16 is a perspective view illustrating a cover;

FIG. 17 is a perspective view illustrating a state in which the receptacle connector and the plug connector are fitted together;

FIG. 18 is a partially enlarged perspective view illustrating the state in which the receptacle housing and the plug housing are fitted together;

FIG. 19A is a perspective view illustrating a signal transmission path;

FIG. 19B is a perspective view illustrating one receptacle connector and one plug connector, with part of the first shells and the plug housing omitted;

FIG. 20 is an exploded perspective view illustrating first locks and a connector coupling body;

FIG. 21 is a perspective view of a coupling portion;

FIG. 22 is a perspective view of the connector coupling body indicating a mounting location of the first lock on the connector coupling body;

FIG. 23 is a perspective view of the connector coupling body;

FIG. 24A is a front view of an electronic connector pair before engagement;

FIG. 24B is a front view of the electronic connector pair after engagement; and

FIG. 25 is a cross-sectional view of the electronic connector pair obtained by cutting the electronic connector pair along a plane parallel to the YZ plane.

### DESCRIPTION OF EMBODIMENTS

Embodiments of the present disclosure are described below in detail with reference to the drawings. The same or equivalent components are given the same reference numerals throughout the drawings. In the present embodiment, description is made appropriately using a three axis orthogonal coordinate system defined by XYZ axes illustrated in the drawings.

### Electrical Connector Pair

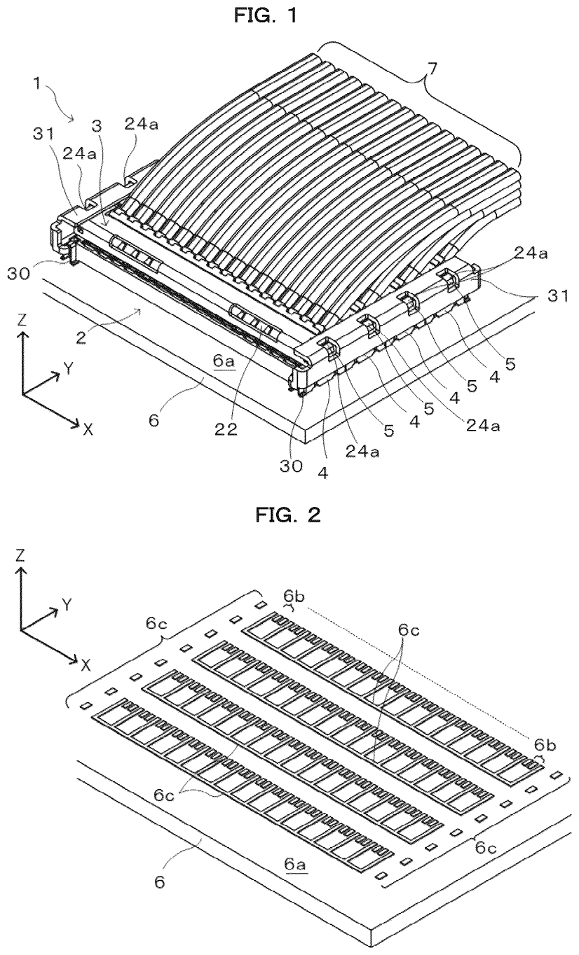

As illustrated in FIG. 1, an electrical connector pair 1 includes a connector coupling body 2 and a connector array body 3. The connector coupling body 2 is configured by arraying and coupling a plurality of receptacle connectors 4 aligned on a mounting surface 6a of a board 6. The connector array body 3 is configured by arraying a plurality of plug connectors 5. The receptacle connector 4 is mounted on the board 6, and the plug connector 5 is connected to a plurality of electrical cables 7.

The receptacle connectors 4 and the plug connectors 5 corresponding one-to-one are fitted together along a normal direction (Z-axis direction) of the mounting surface 6a of the board 6 as a fitting direction. Accordingly, the electrical connector pair 1 connects the board 6 with the plurality of electrical cables 7. When the receptacle connectors 4 and the plug connectors 5 are fitted together, the board 6 and the electrical cables 7 are electrically connected, enabling signal transmission between the electrical circuits and electronic components on the board 6 and the electrical cables 7. The electrical connector pair 1 can be assumed as a connector with a multi-row, multi-column connection structure in which the connector coupling body 2 and the connector array body 3 are fitted together.

### Board

The board 6 is, for example, a printed wiring board or a flexible printed board on which electronic circuits or electronic components are mounted, and is housed within a non-illustrated electronic device or the like. The receptacle connector 4 included in the connector coupling body 2 is connected, by soldering or similar means, to signal electrode patterns 6b and ground electrode patterns 6c, provided on the mounting surface 6a of the board 6, as illustrated in FIG. 2.

As illustrated in FIG. 2, the signal electrode patterns 6b provided on the mounting surface 6a of the board 6 are arrayed in an X-axis direction. Furthermore, four rows of the signal electrode patterns 6b are arrayed in a Y-axis direction.

The ground electrode patterns 6c include two types. One type is a pattern including first portions each sandwiching a pair of signal electrode patterns 6b in the X-axis direction, and a second portion that couples the first portions in the X-axis direction. The other type includes a plurality of patterns arrayed in the Y-axis direction in regions further outward from both ends of the rows of the signal electrode patterns 6b in the X-axis direction.

In the present embodiment, it is assumed that the mounting surface 6a of the board 6 is parallel to an XY plane. Accordingly, the normal direction of the mounting surface 6a is a Z-axis direction. In the present embodiment, description is made appropriately assuming that a plane parallel with the XY plane is a “horizontal plane”, a +Z-direction is an “upward” direction, and a −Z-direction is a “downward” direction.

### Electrical Cable

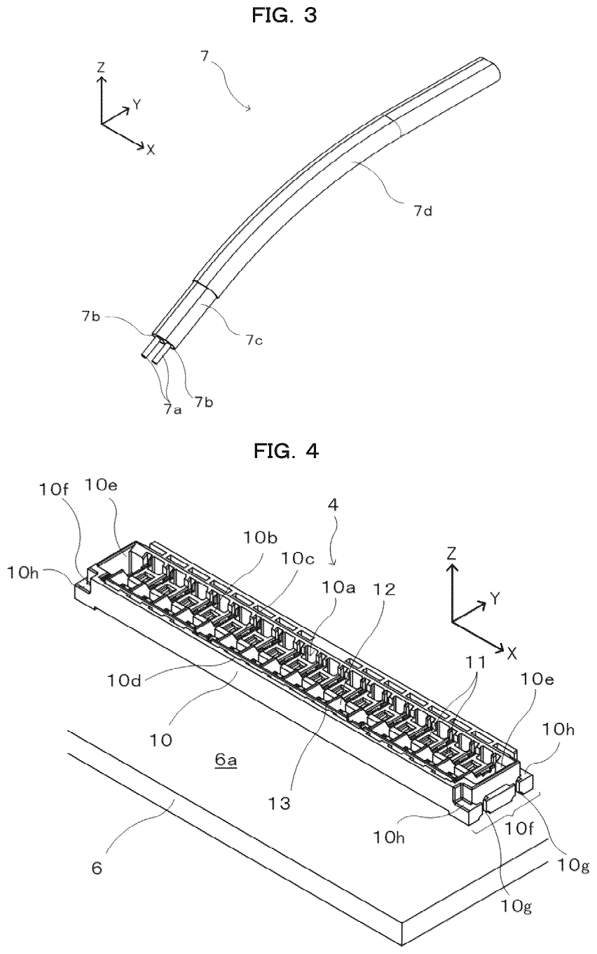

The electrical cable 7 is used for, for example, transmitting an electrical signal between the board 6 accommodated in an electronic device and another board. In the present embodiment, the electrical cable 7 is a two-core flat coaxial cable. As illustrated in FIG. 3, the electrical cable 7 includes a pair of inner conductors 7a, an insulator 7b, an outer conductor 7c, and a protective film 7d. The pair of inner conductors 7a are linearly extending metal wires, for example, copper wires. The insulator 7b covers a circumferential surface of each inner conductor 7a. The outer conductor 7c is a metal braided wire, and covers a circumference of each inner conductor 7a over the insulator 7b. The protective film 7d covers a circumference of the outer conductor 7c. The electrical cable 7 enables signal transmission using a potential difference between the two inner conductors 7a and the outer conductor 7c. The electrical cable 7 is connected to the plug connector 5 in a state arrayed in the X-axis direction.

Note that, the above-described electrical cable 7 is merely an example. For example, the inner conductor 7a may be a stranded wire including a plurality of metal wires, or may be a single metal wire. Further, the outer conductor 7c may be a single wound copper sheet, rather than a metal braided wire.

As illustrated in FIG. 1, the receptacle connectors 4 included in the connector coupling body 2 and the plug connectors 5 included in the connector array body 3 are configured in a manner capable of fitting to and being extracted from each other along the normal direction (Z-axis direction) of the mounting surface 6a of the board 6.

### Connector Coupling Body

A configuration of the connector coupling body 2 is described. First, a detailed configuration of individual receptacle connectors 4 included in the connector coupling body 2 is described.

### Receptacle Connector

As illustrated in FIG. 4, the receptacle connector 4 as a whole is a connector elongated in the X-axis direction and having a flat plate-shaped.

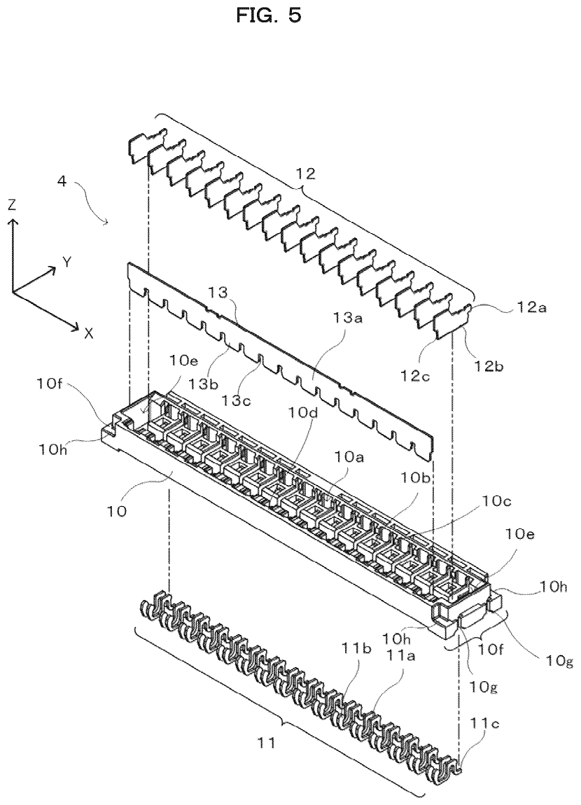

As illustrated in FIG. 5, the receptacle connector 4 includes a receptacle housing 10 facing the mounting surface 6a of the board 6, a plurality of receptacle terminals 11 for signal transmission, a plurality of shield plates 12 forming electromagnetic wave shields, and a ground plate 13 forming an electromagnetic wave shield similarly.

### Receptacle Housing

As illustrated in FIG. 5, the receptacle housing 10 forms a base of the receptacle connector 4. The receptacle housing 10 has a rectangular outer shape, and is elongated in the X-axis direction. The receptacle housing 10 is a member molded from an insulating material containing resin.

The receptacle housing 10 has an upper surface facing the +Z direction. The receptacle housing 10 includes a recess 10a on the upper surface thereof. The recess 10a has an opening extending in the X-axis direction that is a longitudinal direction of the receptacle housing 10.

The recess 10a is provided with a plurality of contact press-fit portions 10b, a plurality of shield plate press-fit portions 10c, and a ground plate press-fit portion 10d. The contact press-fit portions 10b are arrayed in the X-axis direction at regular intervals. A pair of receptacle terminals 11 are press-fitted into each contact press-fit portion 10b from below. The shield plate press-fit portions 10c are located on both sides of each contact press-fit portion 10b in the X-axis direction. The shield plates 12 are press-fitted into the shield plate press-fit portions 10c from above. The ground plate press-fit portion 10d extends in the X-axis direction at a location in the −Y direction relative to the contact press-fit portions 10b and the shield plate press-fit portions 10c. The ground plate 13 is press-fitted into the ground plate press-fit portion 10d from above.

The receptacle housing 10 holds the plurality of receptacle terminals 11 placed in parallel with one another in the X-axis direction, the plurality of shield plates 12, and the ground plate 13. The receptacle housing 10 is interposed between the receptacle terminals 11 and the shield plates 12 and the ground plate 13, and insulates the receptacle terminals 11 from the shield plates 12 and the ground plate 13.

### Receptacle Terminal

The plurality of receptacle terminals 11 are, for example, conductive members acquired by punching an elastic metal plate-shaped member. As illustrated in FIG. 5, the receptacle terminal 11 includes a fixing portion 11a, a receptacle contact portion 11b, and a board connecting portion 11c. As illustrated in FIG. 5, the receptacle terminals 11 are aligned in the same orientation, and the plate thickness direction of the receptacle terminals 11 is the X-axis direction. With this configuration, the fixing portions 11a of the receptacle terminals 11 are inserted upward into the respective contact press-fit portions 10b from below. Thereby, the receptacle terminals 11 are fixed to and held by the receptacle housing 10.

In a state in which the receptacle terminals 11 are fixed to the receptacle housing 10, the receptacle contact portions 11b protrude within the recess 10a of the receptacle housing 10. In a state in which the receptacle terminals 11 are fixed to the receptacle housing 10, the board connecting portions 1 1c are arrayed along the mounting surface 6a of the board 6. The board connecting portions 11c are positioned on and connected to the signal electrode patterns 6b (refer to FIG. 2). In this manner, the receptacle terminals 11 connect to the signal electrode patterns 6b (refer to FIG. 2) provided on the mounting surface 6a, and are in contact with plug terminals 21 of the plug connector 5. The receptacle terminals 11 are arrayed in a single row in the same orientation along the mounting surface 6a, and each pair of the adjacent receptacle terminals 11 as a set transmits a differential signal.

### Shield Plate

The plurality of shield plates 12 are, for example, conductive members acquired by punching an elastic metal plate-shaped member. As illustrated in FIG. 5, the shield plate 12 includes a body 12a and a board connecting portion 12b. As illustrated in FIG. 5, the shield plates 12 are aligned in the same orientation, and the plate thickness direction of the shield plates 12 is the X-axis direction. With this configuration, the shield plates 12 are press-fitted downward into the shield plate press-fit portions 10c from above with the board connecting portions 12b facing downward. The board connecting portions 12b are positioned on and connected, by soldering, to the ground electrode patterns 6c (refer to FIG. 2). Additionally, the shield plate 12 includes a shield plate notch 12c at an end of the board connecting portion 12b in the −Y direction.

### Ground Plate

The ground plate 13 is, for example, a conductive member acquired by punching an elastic metal plate-shaped member. As illustrated in FIG. 5, the ground plate 13 includes a body 13a and board connecting portions 13b. The ground plate 13 extends in the X-axis direction, and the plate thickness direction of the ground plate 13 is the Y-axis direction. With this configuration, the ground plate 13 is press-fitted downward into the ground plate press-fit portion 10d from above with the board connecting portions 13b facing downward. The board connecting portions 13b are positioned on the ground electrode patterns 6c (refer to FIG. 2). Additionally, the ground plate 13 includes ground plate notches 13c between the board connecting portions 13b arrayed in the X-axis direction.

### Summary of Shield Plate and Ground Plate

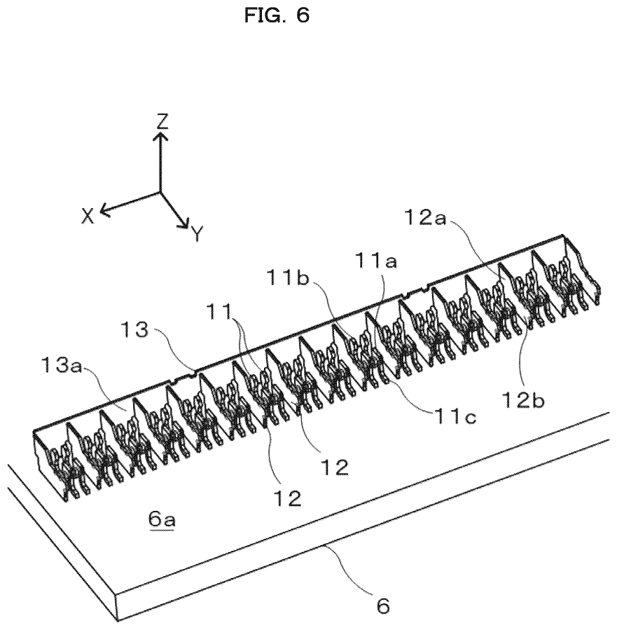

To summarize, as illustrated in FIG. 6, the receptacle terminals 11 are arranged to face in the same direction, and are aligned in a single row on the mounting surface 6a of the board 6 along a direction orthogonal to the orientation of the receptacle terminals 11, that is, along X-axis direction. The adjacent receptacle terminals 11 paired as a set transmit a differential signal. The shield plates 12 are connected to the ground electrode patterns 6c provided on the mounting surface 6a. The shield plates 12 stand upwards at positions partitioning the row of the receptacle terminals 11 into each set and both ends of the row of the receptacle terminals 11, and extend in an orthogonal direction, that is, the Y-axis direction, perpendicular to the array direction of rows of the receptacle terminals 11 within the mounting surface 6a. The ground plate 13 is connected to the ground electrode patterns 6c (refer to FIG. 2) provided on the mounting surface 6a, and stands upwards to extend in the array direction (X-axis direction) of the receptacle terminals 11 in close proximity to one end face in the Y-axis direction (−Y end face) of each shield plate 12.

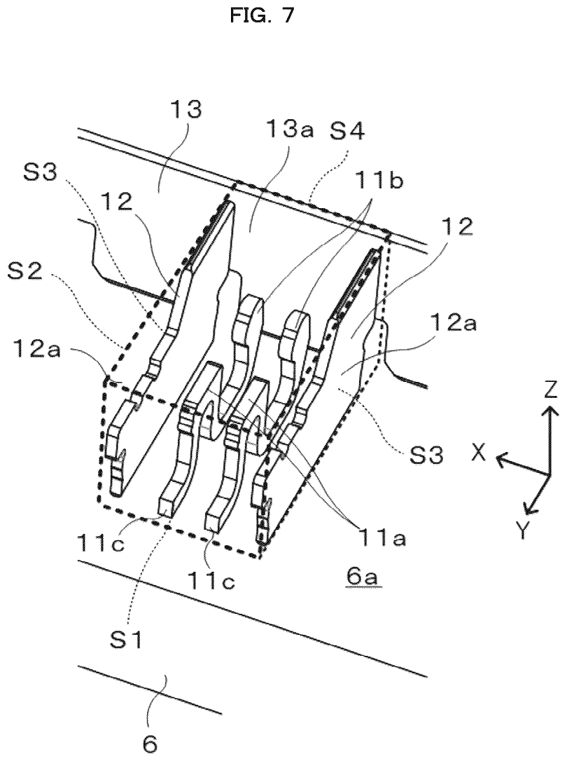

In other words, as illustrated in FIG. 7, the receptacle connector 4 is configured such that five among six planes of a virtual three-dimensional rectangular structure (rectangular parallelepiped) encompassing a set of receptacle terminals 11 are defined. The five planes include a first receptacle plane S1 along the mounting surface 6a, a second receptacle plane S2 parallel to the first receptacle plane S1 and facing the plug connector 5, a pair of third receptacle planes S3 extending along the pair of shield plates 12 sandwiching the set of receptacle terminals 11 transmitting the differential signal, and a fourth receptacle plane S4 extending along the ground plate 13 facing the set of receptacle terminals 11.

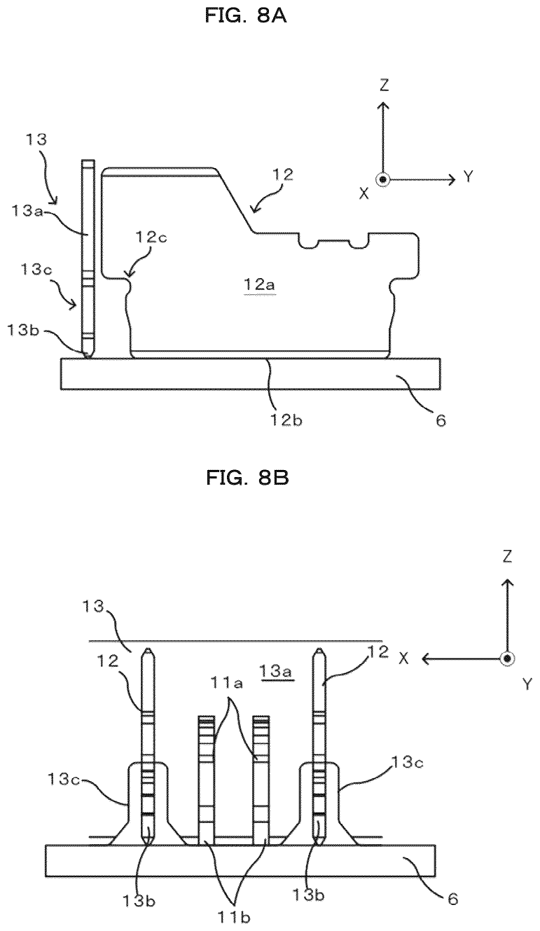

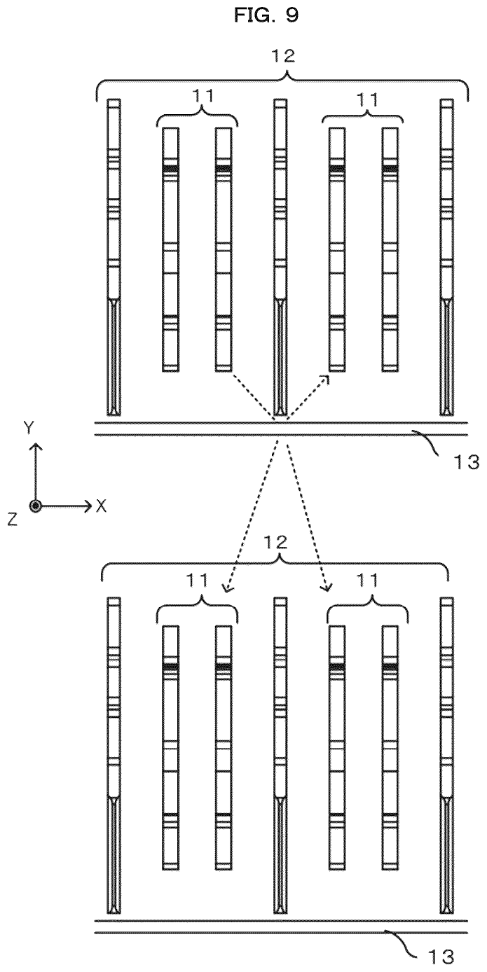

As illustrated in FIG. 8A, as viewed in the X-axis direction, the receptacle terminals 11 are concealed by the shield plate 12. Considering a case where the projected image of the receptacle terminal 11 is projected at a 1:1 scale toward the X-axis direction, the shield plate 12 is positioned and sized to encompass the projected image. Similarly, as illustrated in FIG. 8B, in a case where the projected image of the receptacle terminals 11 as viewed in the Y-axis direction is projected at the 1:1 scale toward the Y-axis direction, the ground plate 13 encompasses the projected image.

The receptacle housing 10 holds the shield plates 12 or the ground plate 13 with the shield plates 12 or the ground plate 13 being press-fitted. Alternatively, the receptacle housing 10 may be molded with the receptacle terminals 11, the shield plates 12, or the ground plate 13 insert-molded. In this case, the receptacle housing 10 holds the shield plates 12 or the ground plate 13 with the receptacle housing 10 being in close contact with the shield plates 12 or the ground plate 13.

As illustrated in FIG. 8A, the shield plate 12 includes the shield plate notch 12c at a position in close proximity to the ground plate 13, that is, a position closest to the ground plate 13. Similarly, as illustrated in FIG. 8B, the ground plate 13 includes the ground plate notches 13c at positions in close proximity to the shield plates 12. This configuration allows the resin portion of the receptacle housing 10 to be arranged within the space provided by the shield plate notches 12c and the ground plate notches 13c. Consequently, during the press-fitting of the shield plates 12 and the ground plate 13 into the receptacle housing 10, this process can be facilitated. Additionally, when the receptacle housing 10 is molded, the molten resin is allowed to flow easily through the shield plate notches 12c and the ground plate notches 13c for insert-molding the shield plates 12 and the ground plate 13. Note that either the shield plate notches 12c or the ground plate notches 13c may be omitted.

Note that both the shield plate notches 12c and the ground plate notches 13c may be omitted. In such cases, when a gap exists between the end faces of the shield plates 12 in the −Y direction and the ground plate 13, it is desirable to fill this gap with solder to connect the shield plates 12 with the ground plate 13. In doing so, the shielding performance of electromagnetic waves by the shield plates 12 and the ground plate 13 can further be enhanced. Furthermore, at least one of the shield plates 12 or the ground plate 13 may have gold plating applied to the surface near the closely adjacent portion. Gold plating is applied over the nickel-plated surface of the ground plate 13. This configuration allows solder to melt and flow over the gold plating during a reflow process, effectively filling the gap between the shield plates 12 and the ground plate 13 with the solder.

As described above, in the receptacle connector 4, three among the six surfaces surrounding the receptacle terminal 11 are enclosed by the pair of shield plates 12 and the ground plate 13. The planes not surrounded are the mounting surface 6a of the board 6 (the first receptacle plane S1), the plane facing the plug connector 5 (the second receptacle plane S2), and the plane facing the +Y direction. Among these, the surface facing the +Y direction is enclosed by a ground plate 13 of another receptacle connector 4 located in the +Y direction. Therefore, when the receptacle connector 4 is fitted to the plug connector 5, the majority of the area around the receptacle terminals 11 can be enclosed by an electromagnetic shield of the plug connector 5 and an electromagnetic shield of the receptacle connector 4, thereby improving the electromagnetic shielding performance of the electrical connector pair 1.

When an electromagnetic shield plate in which the electromagnetic shield surrounding the pair of receptacle terminals 11 is bent into a U-shape to have three sides is used instead of the pair of shield plates 12 and the single ground plate 13, the gap between the electromagnetic shield plates needs to have a size that allows resin to enter. Additionally, areas in which the electromagnetic shield plates overlap are inevitably generated, and extra space is required for the bent portions, resulting in a larger area occupied by the electromagnetic shield surrounding the pair of receptacle terminals 11. By contrast, by configuring the electromagnetic shield surrounding the pair of receptacle terminals 11, as in receptacle connector 4, to be the pair of shield plates 12 and the single ground plate 13, the space occupied by the electromagnetic shield enclosing surrounding the pair of receptacle terminals 11 can be reduced. Furthermore, this configuration renders unnecessary U-shaped electromagnetic shield plate for each pair of receptacle terminals 11, which results in reducing the number of components and simplifying the structure of the receptacle connector 4.

Additionally, each shield plate 12 includes the shield plate notch 12c, and the ground plate 13 includes the ground plate notches 13c. As illustrated in FIG. 9, the shield plate notches 12c and the ground plate notches 13c are positioned at the corners of the space surrounded by the electromagnetic shield. This arrangement increases the distance from the pair of receptacle terminals 11 to the shield plate notches 12c and the ground plate notches 13c. As illustrated in FIG. 9, in a case where the electromagnetic waves emitted from the receptacle terminal 11 pass through the shield plate notch 12c and the ground plate notch 13c, and the electromagnetic waves enter another receptacle terminal 11, the path of the electromagnetic waves can be configured as a bent trajectory. Therefore, the reduction in the shielding performance of the electromagnetic shield (near-end crosstalk and far-end crosstalk) can be minimized.

### Plug Connector

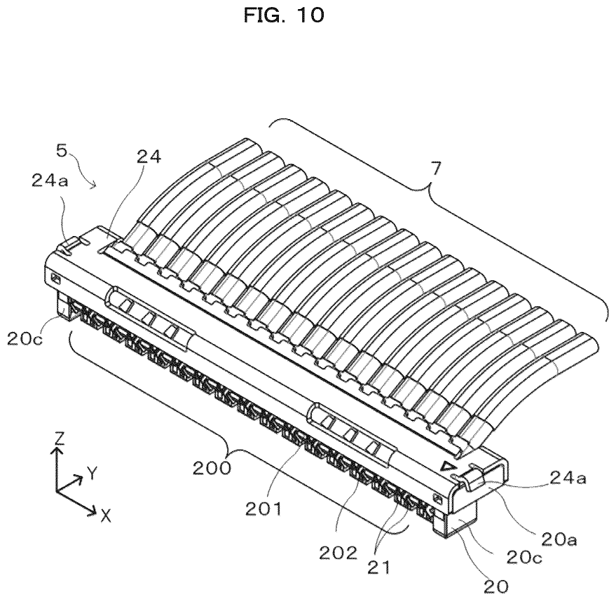

Next, the plug connector 5 fitted to the receptacle connector 4 in a one-to-one manner is described. As illustrated in FIGS. 10 to 16, the plug connector 5 includes a plug housing 20 as a base, a plurality of plug terminals 21 as a signal transmission path, a plurality of first shells 22 as the electromagnetic shields between the plurality of plug terminals 21 and the outside, a second shell 23 as the electromagnetic shield, and a cover 24 to enhance the rigidity of the plug connector 5. Note that the XYZ coordinate system in FIGS. 10 to 16 corresponds to the state in which the plug connector 5 is fitted to the receptacle connector 4.

### Plug Housing and Plug Terminal

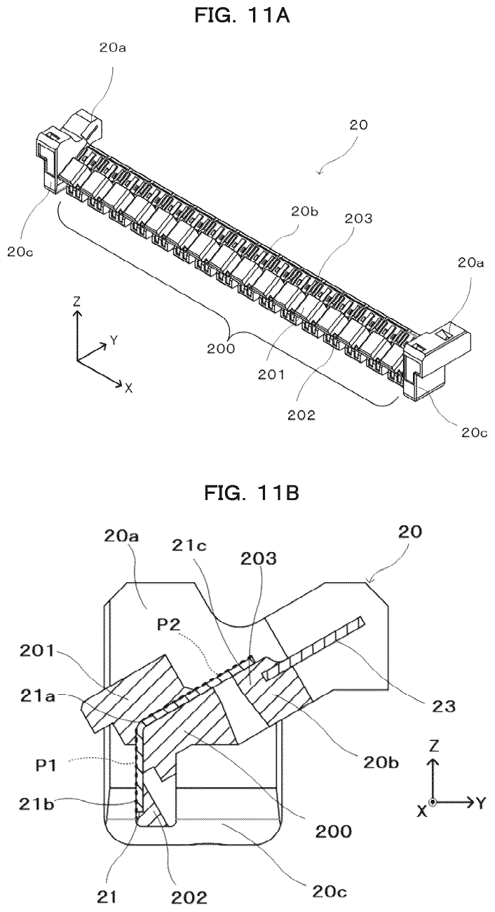

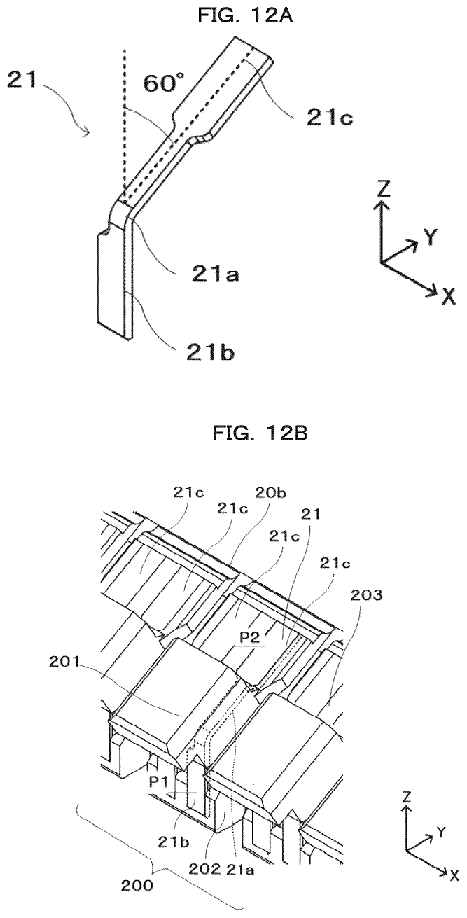

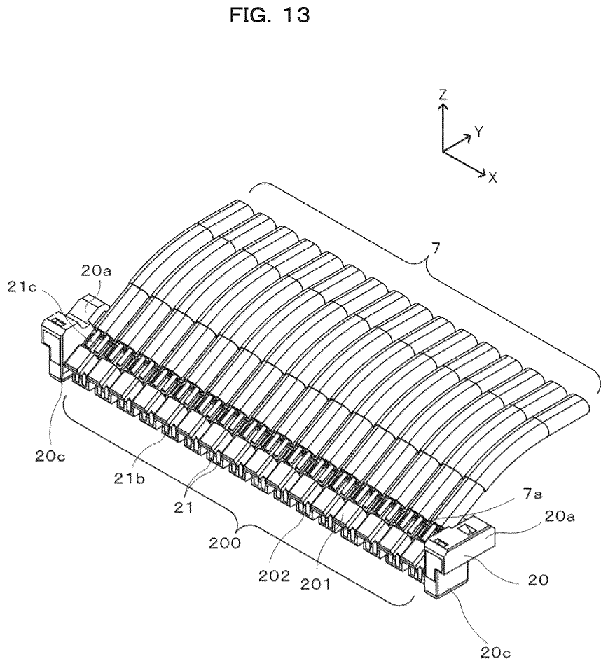

The plug housing 20 is, for example, an insulating member made of resin. As illustrated in FIG. 11A, the plug housing 20 as a whole is a member elongated in the X-axis direction that is a longitudinal direction of the plug housing 20. At both ends of the plug housing 20 in the X-axis direction, cover connecting portions 20a connecting to the cover 24, which is described below, are provided. Between the two cover connecting portions 20a, a plug array portion 20b is provided. The plurality of plug terminals 21 are arrayed in the plug array portion 20b. The plug array portion 20b included in the plug housing 20 holds the plurality of plug terminals 21 (refer to FIG. 12B) arrayed in a single direction while maintaining the same orientation. The plug array portion 20b has a shape in which plug mounting portions 200 are coupled to each other in the X-axis direction. The pair of plug terminals 21 are arranged in the plug mounting portion 200.

The plug terminals 21 are, for example, conductive members acquired by punching an elastic metal plate-shaped member. As illustrated in FIG. 12A, the plug terminal 21 includes a fixing portion 21a fixed to the plug housing 20, a plug contact portion 21b that makes one-to-one contact with the conductive receptacle terminal 11 of the receptacle connector 4, and a cable connecting portion 21c connected to the inner conductor 7a of the electrical cable 7. The fixing portion 21a is located at the center of the plug terminal 21 extending in the vertical direction. The plug contact portion 21b extends in a downward direction from the fixing portion 21a. The cable connecting portion 21c extends in a direction inclined relative to an upward direction by 60° in the Y direction along a YZ plane. The plug contact portion 21b makes contact with the receptacle terminal 11 at a portion along the fitting direction (Z-axis direction) while fitting with the receptacle connector 4. The cable connecting portion 21c connects, at a portion along an inclining direction, with the inner conductor 7a of the electrical cable 7 extending in the inclining direction. The inclining direction is a direction inclined from the fitting direction (Z-axis direction) toward an orthogonal direction (Y-axis direction) orthogonal to both the array direction and the fitting direction.

As illustrated in FIG. 12B, the fixing portion 21a is embedded in the plug mounting portion 200. The plug contact portion 21b extends in the Z-axis direction and, as described later, makes contact with the receptacle contact portion 11b (refer to FIG. 5) of the receptacle terminal 11. The cable connecting portion 21c extends along the YZ plane, inclined from the +Z direction toward the +Y direction, and, as illustrated in FIG. 13, connects to the inner conductor 7a of the electrical cable 7 by soldering.

As illustrated in FIG. 11B, the plug mounting portion 200 included in the plug housing 20 includes a plug fixing portion 201, a fitting portion 202, and a supporting portion 203. In the plug terminal 21, at least a portion between the plug contact portion 21b and the cable connecting portion 21c, specifically the fixing portion 21a, is tightly fixed to the plug fixing portion 201 of the plug housing 20. Note that FIG. 11B also illustrates the plug terminal 21 and the second shell 23.

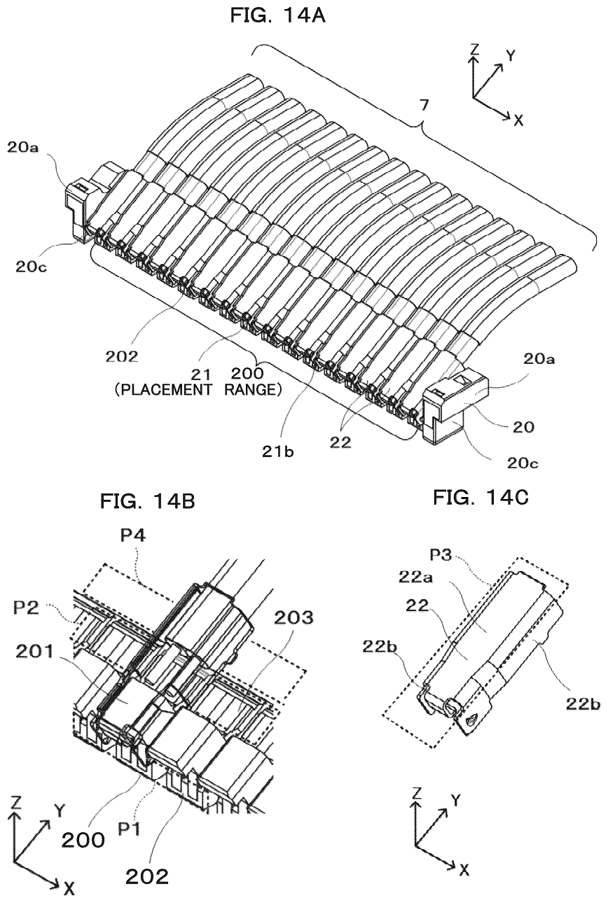

As illustrated in FIG. 14B, the fitting portion 202 supports the plug contact portion 21b on a first plug plane P1. The first plug plane P1 fits with the recess 10a of the receptacle connector 4 in the vertical direction, and extends in the fitting direction (Z-axis direction) and the array direction (X-axis direction) of the plug terminals 21. The supporting portion 203 is coupled to the fitting portion 202, and supports the cable connecting portion 21c of the plug terminal 21 on a second plug plane P2. The second plug plane P2 extends in the inclining direction in which the cable connecting portion 21c extends and in the array direction (X-axis direction).

### First Shell

The first shell 22 is an elastic and conductive member acquired by punching and bending a metal plate member. As illustrated in FIG. 13, in the plug connector 5, a pair of adjacent plug terminals 21 as a set is connected to a single electrical cable 7, and transmits a differential signal. As illustrated in FIGS. 14A and 14B, the first shell 22 is provided for each pair of adjacent plug terminals 21 in a state in which the first shell 22 is insulated from the plug terminals 21 by the protrusion of the plug fixing portion 201. As illustrated in FIG. 14B, the first shell 22 covers a portion of the plug terminals 21 excluding the plug contact portions 21b.

As illustrated in FIGS. 14B and 14C, the first shell 22 includes an opposing wall portion 22a covering the pair of plug terminals 21 on a third plug plane P3. The third plug plane P3 is parallel to the second plug plane P2, and extends in the inclining direction in which the cable connecting portion 21c extends, and in the array direction of the plug terminals 21. The first shell 22 also includes a pair of side wall portions 22b arranged with the pair of plug terminals 21 therebetween in the array direction (X-axis direction) of the plug terminals 21.

### Second Shell

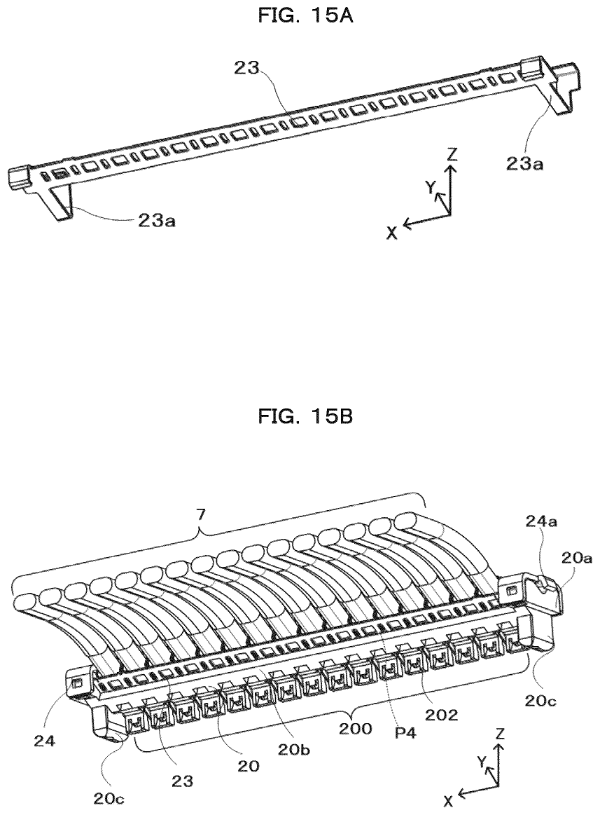

The second shell 23 is an elastic and conductive member acquired by punching and bending a metal plate member. As illustrated in FIGS. 15A and 15B, the second shell 23 covers the plurality of plug terminals 21 on a fourth plug plane P4 (refer to FIG. 14B), that is, from the opposite side of the first shells 22 relative to the cable connecting portions 21c. The fourth plug plane P4 extends in the inclining direction in which the cable connecting portion 21c extends, and in the array direction (X-axis direction) of the plug terminals 21, and is provided on the opposite side of the third plug plane P3 with respect to the second plug plane P2. In the plug connector 5, the first shell 22 and the second shell 23 together form an electromagnetic shield surrounding the pair of plug terminals 21 from all directions. Additionally, at both ends of the second shell 23 in the X-axis direction, extended portions 23a are provided, extending in the −Z direction to contact the shield plates 12 of the receptacle connector 4.

### Cover

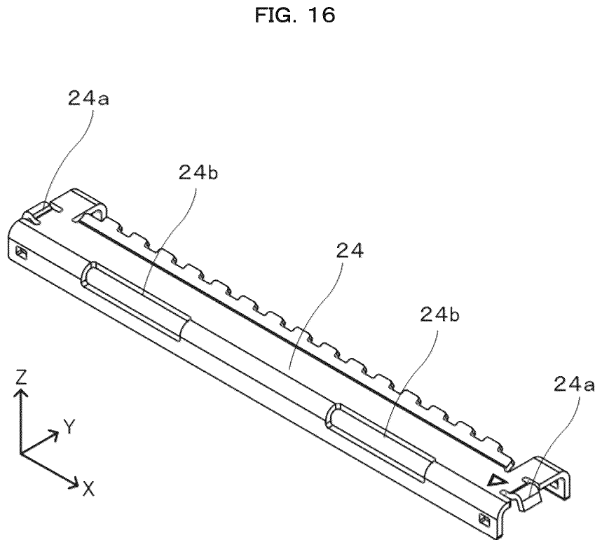

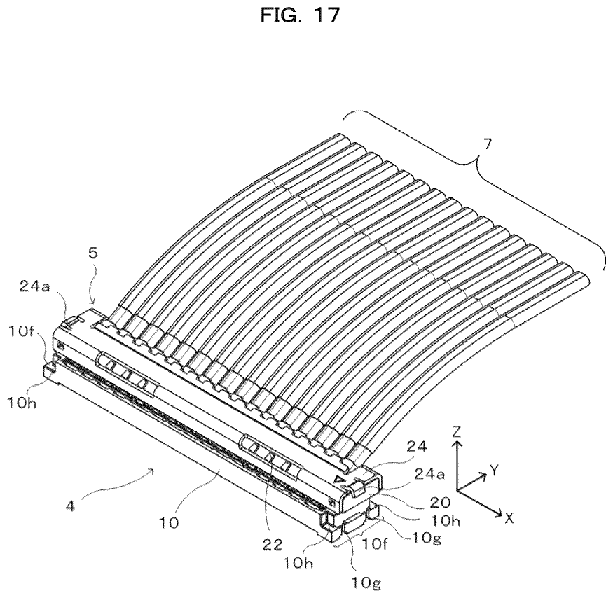

The cover 24 is an elastic and conductive member acquired by punching and bending a metal plate member. As illustrated in FIG. 16, the cover 24 is attached to the cover connecting portions 20a provided at both ends of the plug housing 20 in the X-axis direction, covering the plurality of plug terminals 21 from above the first shells 22. The cover 24 enhances the mechanical strength of the plug connector 5. Additionally, the cover 24 has two notches 24b provided in the X-axis direction. The notches 24b allow a jig to engage. The jig is used for removing the plug connector 5 fitted to the receptacle connector 4.

The configuration of the plug connector 5 is described above. In the plug connector 5, the cable connecting portions 21c are inclined from the vertical direction toward the horizontal direction. As a result, the size of the plug connector 5 in the vertical direction can be reduced, enabling a reduction in height of the electrical connector pair 1.

### Fitting of Receptacle Connector and Plug Connector

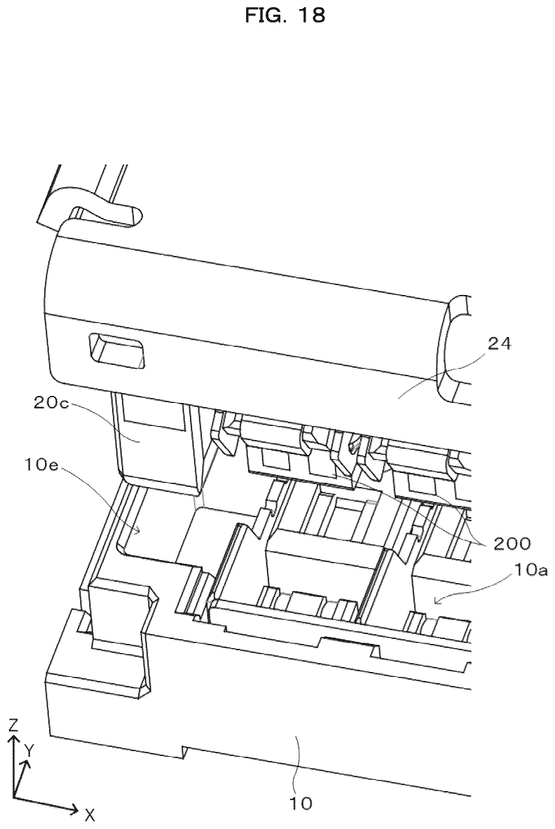

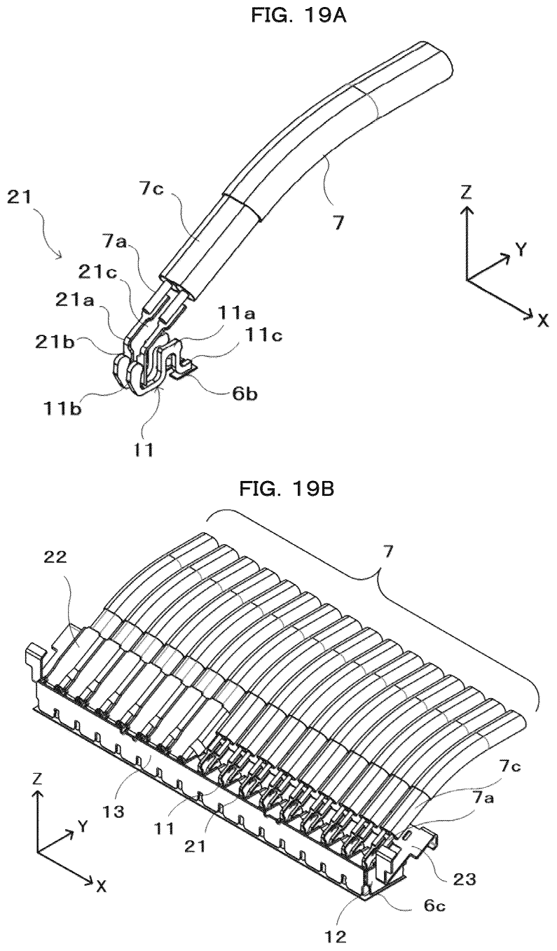

As illustrated in FIG. 17, in the electrical connector pair 1, the receptacle connector 4 and the plug connector 5 are fitted together. As illustrated in FIG. 18, the receptacle housing 10 includes fitting recesses 10e at both ends in the X-axis direction, and the plug housing 20 includes fitting protrusions 20c at both ends in the X-axis direction. When the receptacle connector 4 and the plug connector 5 are fitted together, the fitting protrusions 20c of the plug housing 20 are inserted into the fitting recesses 10e of the receptacle housing 10. This ensures the fitting position of the plug connector 5 with respect to the receptacle connector 4.

The fitting of the receptacle connector 4 and the plug connector 5 allows the receptacle terminals 11 and the plug terminals 21 to contact in a one-to-one manner. As a result, as illustrated in FIG. 19A, a signal transmission path is formed, connecting to the signal electrode pattern 6b of the board 6, the receptacle terminal 11, the plug terminal 21, and the inner conductors 7a of the electrical cable 7. Additionally, as illustrated in FIG. 19B, the pair of receptacle terminals 11 and the pair of plug terminals 21 are surrounded by the shield plates 12, the ground plate 13, the first shell 22, and the second shell 23. The shield plates 12, the ground plate 13, the first shell 22, and the second shell 23 are connected to one another, and are further connected to the outer conductor 7c of the electrical cable 7 and the ground electrode pattern 6c, functioning as an electromagnetic shield around the signal transmission path.

### Connector Coupling Body and Connector Array Body

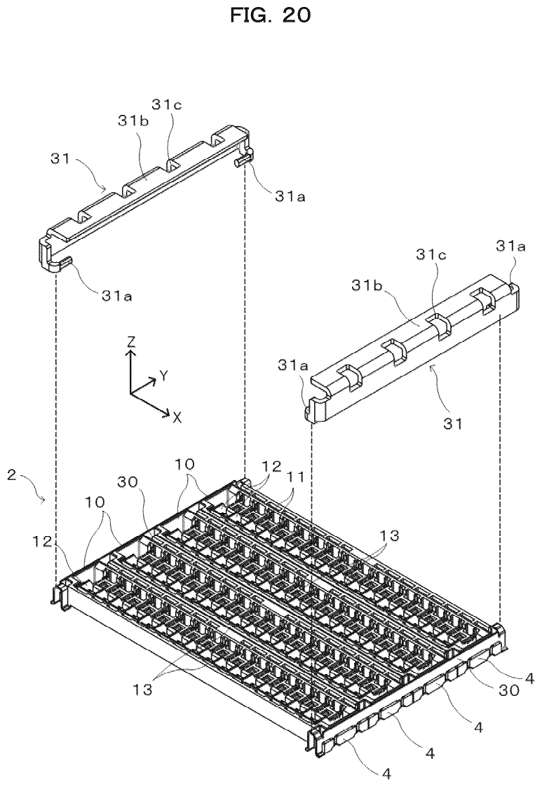

As illustrated in FIG. 20, the rows of receptacle connectors 4 are mounted on the mounting surface 6a of the board 6, being arrayed in close proximity to each other in the Y-axis direction, while a longitudinal direction of each row of receptacle connector 4 being aligned in the X-axis direction. In the present embodiment, the number of rows of receptacle connectors 4 in an array is four. However, this is not limited to four, and the number of rows of receptacle connectors 4 in an array can be any number.

### Coupling Member

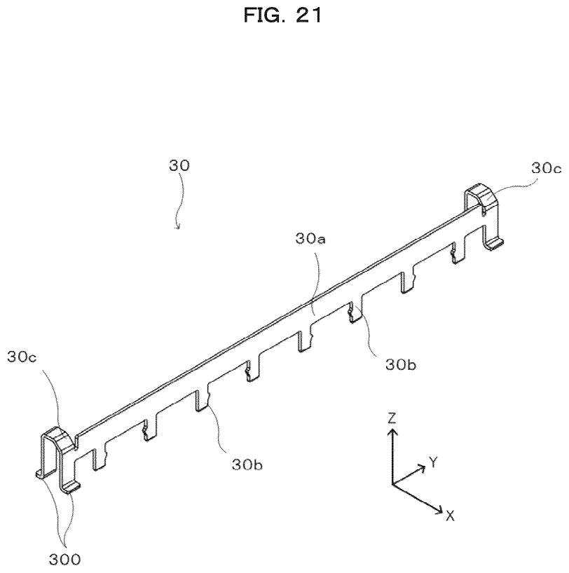

The plurality of receptacle connectors 4 are coupled to one another at both ends in the X-axis direction by coupling portions 30. As illustrated in FIG. 21, the coupling portion 30 is an elastic and conductive member acquired by punching and bending a metal plate member. The coupling portion 30 includes a body 30a extending in the Y-axis direction (first direction), a plurality of extended portions 30b extending downward from the body 30a, and an axis support 30c supporting a rotational axis of a first lock 31, which is described later.

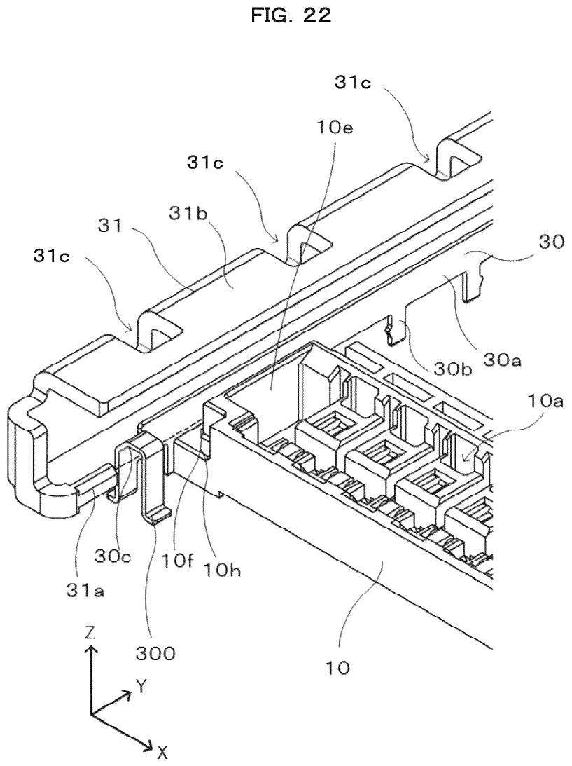

The length of the body 30a in the Y-axis direction (first direction) is the same as the length of the array of four rows of the receptacle connectors 4. Conversely, as illustrated in FIG. 22, the receptacle housing 10 includes protruding portions 10f extending outward along the X-axis direction at lower portions of both ends of the receptacle housing 10 in the X-axis direction. The upper surface of the protruding portion 10f is horizontal, and the body 30a is placed on the upper surface.

The extended portions 30b are provided as a pair for a receptacle connector 4. Conversely, the protruding portion 10f of the receptacle housing 10 is provided with receiving portions 10g to receive the extended portions 30b (refer to FIG. 17). When the extended portions 30b are inserted and press-fitted into the receiving portions 10g, each body 30a is placed on the upper surface of the protruding portion 10f, enabling the coupling portions 30 to connect the plurality of receptacle connectors 4. A lower end of the extended portion 30b is connected to the ground electrode pattern 6c (refer to FIG. 2) provided on the mounting surface 6a of the board 6.

### Axis Support

As illustrated in FIG. 21, a pair of axis supports 30c is provided at and coupled to both ends of the coupling portion 30 in the Y-axis direction. The axis support 30c is bent into an inverted U-shape as viewed in the Y-axis direction. The lower ends of the pair of axis supports 30c are connected by soldering to the ground electrode patterns 6c (refer to FIG. 2) on the mounting surface 6a of the board 6. The axis support 30c includes board connecting portions 300 that connect to the board 6. The axis support 30c is provided directly above the board connecting portions 300. “Directly above” refers to the condition where an object is located upward relative to another object. As illustrated in FIG. 22, four corners of the receptacle housing 10, as viewed from above, are notched. Each corner is provided with an axis support 10h having a surface connected to the upper surface of the protruding portion 10f.

With the above configuration, the coupling portion 30 extends in the Y-axis direction, and connects the plurality of receptacle connectors 4.

### First Lock

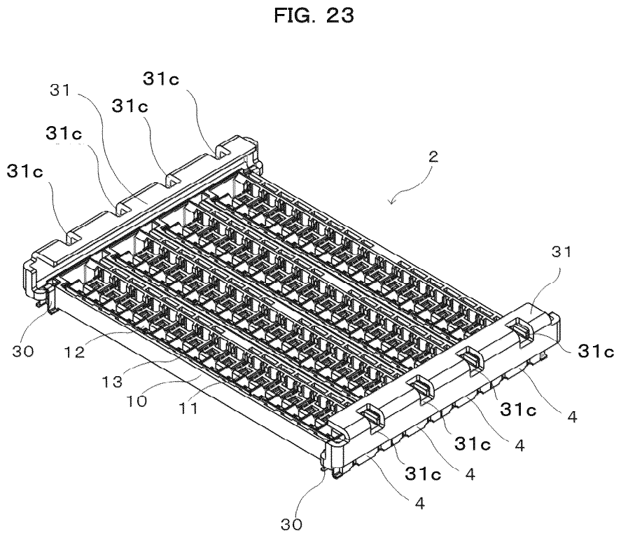

As illustrated in FIG. 23, the connector coupling body 2 includes a pair of first locks 31. The first locks 31 are provided at both ends, in the X-axis direction, of the rows of receptacle connectors 4 in an array. The first lock 31 is an elastic and conductive member acquired by punching and bending a metal plate member. The first lock 31 includes a pair of rotation center portions 31a and an abutment 31b (refer to FIG. 22). Additionally, the abutment 31b is provided with notches 31c.

### Rotation Center Portion

The rotation center portions 31a are provided at both ends of the first lock 31 in the Y-axis direction. The both ends correspond to the both ends of the array of rows receptacle connectors 4. As illustrated in FIG. 22, the rotation center portion 31a passes through the U-shaped portion of the axis support 30c included in the coupling portion 30, and is placed on the upper surface of the axis support 10h of the receptacle housing 10, thereby being supported by the coupling portion 30 and the receptacle housing 10. The rotation center portion 31a rotates about a rotational axis along the Y-axis direction. Note that the rotation center portion 31a may be supported solely by the receptacle housing 10, or solely by the coupling portion 30. In this way, it suffices for the rotation center portion 31a to be rotatably supported by an axis support provided to at least one of the receptacle housing 10 or the coupling portion 30.

### Abutment

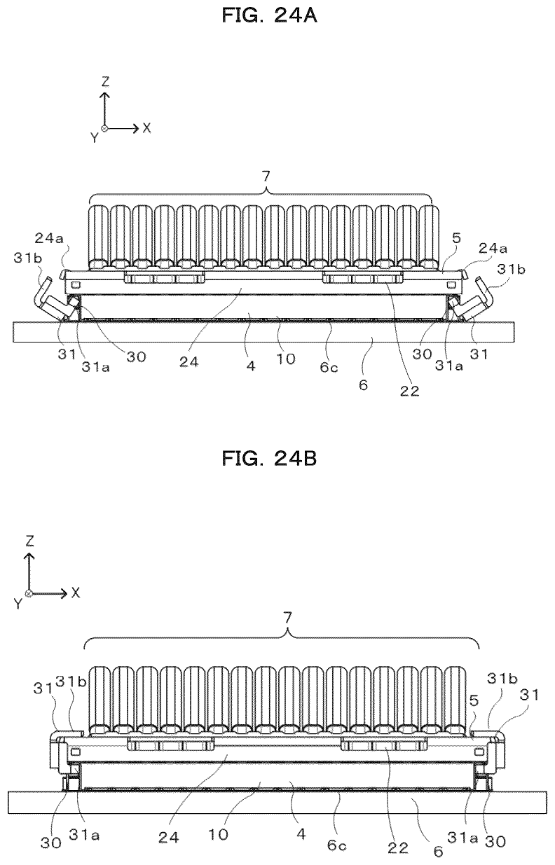

The abutment 31b is an L-shaped member, as viewed in the Y-axis direction. As illustrated in FIGS. 24A and 24B, the abutment 31b can change its position around the rotation center portion 31a.

### Second Lock

Conversely, as illustrated in FIG. 16, the plug connector 5 includes second locks 24a. The second locks 24a are provided at both ends of the cover 24 in the X-axis direction. The second lock 24a is part of the cover 24, and is a flexible member that protrudes outward relative to the cover 24, and bends.

### Engagement Between First Lock and Second Lock

In the connector coupling body 2, with the first lock 31 in its open state, that is, in a state in which the first lock 31 is positioned at a first position illustrated in FIG. 24A, the plug connector 5 is inserted into the receptacle connector 4 from above, and the two are fitted together. Once the fitting of the receptacle connector 4 and the plug connector 5 is complete, as illustrated in FIG. 24B, the first lock 31 rotates to a second position illustrated in FIG. 24B. During this rotation, the abutment 31b of the first lock 31 contacts the second lock 24a, causing the second lock 24a to deform. The second lock 24a abuts against the first lock 31 to elastically-deform. When the first lock 31 reaches the second position illustrated in FIG. 24B, the shape of the elastically-deformed second lock 24a aligns with the notch 31c, returning to its original shape. This achieves the engagement between the first lock 31 and the second lock 24a.

To release the fitting between the receptacle connector 4 and the plug connector 5, the first lock 31 may be rotated from the second position illustrated in FIG. 24B, where it is engaged with the second lock 24a, back to the first position illustrated in FIG. 24A, where it is disengaged from the second lock 24a. That is, the second lock 24a enables engagement with and disengagement from the first lock 31. Note that the first lock 31 can engage with and disengage from the second locks 24a by sliding rather than by rotating.

As illustrated in FIG. 1, the abutment 31b included in the first lock 31 extends across the plurality of receptacle connectors 4. This allows the first lock 31 to lock the plurality of receptacle connectors 4 together.

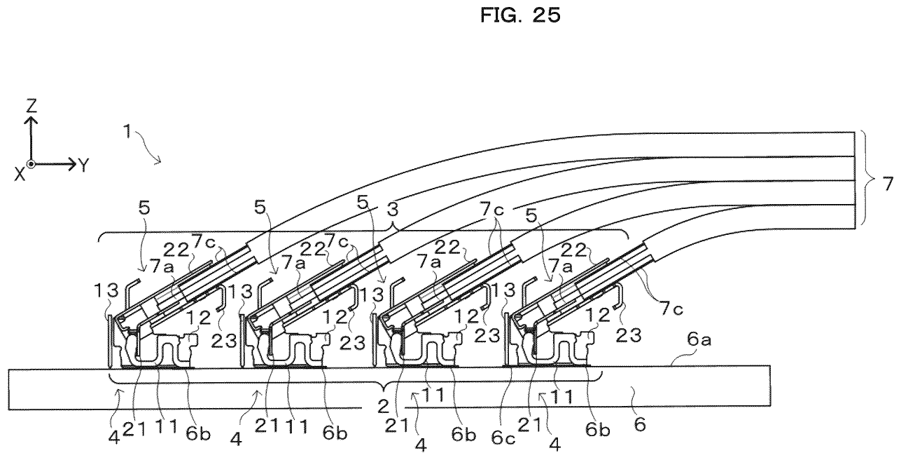

As illustrated in FIG. 25, the signal transmission paths formed by each receptacle connector 4 and each plug connector 5 are identical, and the lengths of the paths are the same. This ensures impedance matching among the transmission paths even in a case where the receptacle connectors 4 are arrayed, and are fitted to the plug connectors 5 in a one-to-one manner. Additionally, as illustrated in FIG. 25, even in a case where the receptacle connectors 4 are arrayed, and are fitted to the plug connectors 5 in a one-to-one manner, the electrical cables 7 can be pulled out diagonally upward from the respective fitted plug connectors 5, enabling a reduction in height of the electrical connector pair 1. That is, according to the electrical connector pair 1, even in a case where the receptacle connectors 4 are arrayed, and are fitted to the plug connectors 5 in a one-to-one manner, impedance matching can be achieved, enabling a reduction in height of the electrical connector pair 1.

As illustrated in FIG. 25, a series of transmission paths connecting to the receptacle terminal 11, the plug terminal 21, and the inner conductor 7a of the electrical cable 7 is surrounded by the ground plate 13, the shield plates 12, components of the first shell 22, and the second shell. This enhances the shielding performance of the electromagnetic shield of the electrical connector pair 1.

In the present embodiment, plug connectors 5 are fitted to all receptacle connectors 4. However, this is not limited to all; a plug connector 5 may be fitted to at least one receptacle connector 4.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the priority of Japanese Patent Application No. 2023-024698, filed on Feb. 20, 2023, the entire disclosure of which is incorporated by reference herein.

### REFERENCE SIGNS LIST

1 Electrical connector pair
2 Connector coupling body
3 Connector array body
4 Receptacle connector (mating connector)
5 Plug connector (electrical connector)
6 Board
6a Mounting surface
6b Signal electrode pattern
6c Ground electrode pattern
7 Electrical cable
7a Inner conductor (signal line)
7b Insulator
7c Outer conductor
7d Protective film
10 Receptacle housing
10a Recess
10b Contact press-fit portion
10c Shield plate press-fit portion
10d Ground plate press-fit portion
10e Fitting recess
10f Protruding portion
10g Receiving portion
10h Axis support
11 Receptacle terminal (signal transmission member)
11a Fixing portion
11b Receptacle contact portion
11c Board connecting portion
12 Shield plate
12a Body
12b Board connecting portion
12c Shield plate notch
13 Ground plate
13a Body
13b Board connecting portion
13c Ground plate notch
20 Plug housing (housing)
20a Cover connecting portion
20b Plug array portion
20c Fitting protrusion
21 Plug terminal (contact)
21a Fixing portion
21b Plug contact portion (contact portion)
21c Cable connecting portion (connecting portion)
22 First shell
22a Opposing wall portion
22b Side wall portion
23 Second shell
23a Extended portion
24 Cover
24a Second lock
30 Coupling portion
30a Body
30b Extended portion
30c Axis support
31 First lock
31a Rotation center portion
31b Abutment
200 Plug mounting portion
201 Plug fixing portion
202 Fitting portion
203 Supporting portion
S1 First receptacle plane
S2 Second receptacle plane
S3 Third receptacle plane
S4 Fourth receptacle plane
S5 Fifth receptacle plane
P1 First plug plane (first plane)
P2 Second plug plane (second plane)
P3 Third plug plane (third plane)
P4 Fourth plug plane (fourth plane)

1. An electrical connector to be fitted to a mating connector mounted on a board in a normal direction of a mounting surface of the board that is a fitting direction and to connect the mating connector with a signal line, the electrical connector comprising:
contacts being conductive, arranged in a same orientation, and arrayed to connect to signal transmission members of the mating connector in a one-to-one manner, the signal transmission members being conductive and arrayed on the mounting surface of the board; and
a housing being insulative and holding the contacts, wherein
the contacts each include
a contact to make contact with the corresponding signal transmission member, and
a connecting portion to connect to the signal line, and
when the electrical connector is fitted to the mating connector, the contact portion comes in contact, at a portion along the fitting direction, with the signal transmission member, and the connecting portion connects, at a portion along an inclining direction, with the signal line extending in the inclining direction, the inclining direction being a direction inclined from the fitting direction toward an orthogonal direction orthogonal to both an array direction of the contacts and the fitting direction.

2. The electrical connector according to claim 1, wherein
the housing includes
a fitting portion that fits to the mating connector, and supports the contact portions on a first plane, the first plane extending in the fitting direction and the array direction, and
a supporting portion that is coupled to the fitting portion, and supports the connecting portion on a second plane, the second plane extending in the inclining direction and the array direction.

3. The electrical connector according to claim 1, wherein
in each contact, at least a portion between the contact portion and the connecting portion is tightly fixed to the housing.

4. The electrical connector according to claim 1, further comprising:
a first shell being conductive, wherein
a pair of adjacent contacts, among the contacts, transmits a differential signal as a set, and
the first shell covers at least a portion of the pair of contacts, and is provided for each pair of contacts in a state in which the first shell is insulated from the contacts.

5. The electrical connector according to claim 4, wherein
the first shell covers a portion of the contact that excludes the contact portion.

6. The electrical connector according to claim 5, wherein
the first shell includes an opposing wall portion, the opposing wall portion extending in the inclining direction and the array direction and covering the pair of contacts.

7. The electrical connector according to claim 6, wherein
the first shell includes a pair of side wall portions arranged with the pair of contacts therebetween in the array direction.

8. The electrical connector according to claim 4, further comprising:
a second shell being conductive, extending in the inclining direction and the array direction, and covering the contacts from an opposite side of the first shell relative to the connecting portion.

9. The electrical connector according to claim 4, further comprising:
a cover being conductive and covering an array of the contacts from above the first shell.

10. An electrical connector pair, comprising:
mating connectors that each include the signal transmission members being conductive and aligned on the mounting surface of the board, and in which the signal transmission members are aligned in an orthogonal direction that is orthogonal to an array direction of the signal transmission members, and to the fitting direction so that the signal transmission members are arranged in a same orientation, and
the electrical connector according to claim 1, the electrical connector fitting to the mating connectors in the normal direction of the mounting surface in a one-to-one manner.
